(19) United States
(12) Patent Application Publication
(10) Pub. No.: US 2009/0210155 A1
(43) Pub. Date: Aug. 20, 2009

(54) AUTOMOTIVE ENTERTAINMENT, COMMUNICATION, NAVIGATION AND CONTROL CENTER

(75) Inventors: Tomer Yosef Morad, Tel-Aviv (IL); Leonid Yavits, Herzlia (IL); Amir Morad, Tel-Aviv (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(73) Assignee: HORIZON SEMICONDUCTORS LTD., Herzliya (IL)

(21) Appl. No.: 12/355,820

(22) Filed: Jan. 19, 2009

Related U.S. Application Data
(60) Provisional application No. 61/064,122, filed on Feb. 19, 2008.

(51) Int. Cl. G06F 19/00

(52) U.S. Cl. 701/213

(57) ABSTRACT

Apparatus for automotive entertainment, navigation, communication and control, including a plurality of radio, TV, video and audio inputs, a video and audio output, a plurality of wireless communication channels, and a plurality of receivers, transceivers and processing units.

### FIELD OF THE INVENTION

The present invention relates to automotive entertainment, communication, navigation and control systems, and in particular to System on a Chip (SoC) devices which combine automotive entertainment, communication, navigation, and control systems.

### BACKGROUND OF THE INVENTION

Audio and video entertainment systems integrated in vehicles such as cars, mini-vans, and sport utility vehicles are becoming popular. Navigation systems such as GPS have become wide spread. Automotive communication primarily based on embedded telephones and/or portable cell-phones is widely used. Accordingly, special systems for driver and passengers to watch videos, listen to satellite radio, play video games, navigate using GPS, communicate with the external world by means of voice or data have been developed.

However, adding the capability of live terrestrial or satellite video reception, enabling additional communication applications such as communicating with a remote fleet management server, remote upgrades, enabling in-vehicle wireless communication are highly advantageous. Furthermore, integration of entertainment, communication, navigation and control infrastructures into one combined device and implementation of such device, entirely or in parts using system-on-chip technologies provides additional significant advantages in terms of cost as well as enabling new applications and services.

It is an object of the present invention to provide an automotive entertainment, communication, and navigation system.

It is another object of the present invention to provide an automotive transmit-receive communication and navigation system.

It is still another object of the present invention to provide an automotive entertainment, communication, and navigation system which can be easily and regularly updated.

It is still another object of the present invention to provide an efficient fleet management system.

It is still another object of the present invention to provide an automotive security system.

It is still another object of the present invention to provide a chip implementable system for automotive entertainment, communication, navigation, security and control.

Other objects and advantages of the invention will become apparent as the description proceeds.

### SUMMARY OF THE INVENTION

The present invention relates to an automotive entertainment, navigation and communication system comprising: (a) an RF receiver and decoder for receiving input signals, decoding said signals and outputting the decoded signals; (b) a back-end for processing video, audio, or graphics, of said decoded signals; (c) a GPS receiver for receiving terrestrial data; (d) an APU connected to said RF receiver, said back-end, and said GPS receiver, for processing said signals and said terrestrial data, and for controlling said RF receiver, said back-end, and said GPS receiver.

Preferably, the system further comprises a non volatile memory for storing information.

Preferably, the system further comprises a media drive for playing audio or video data.

Preferably, the system further comprises a short range wireless transceiver for communicating between the APU and portable peripherals;

Preferably, the system further comprises a long range wireless transceiver for communicating between the APU and a remote server.

In one embodiment, the system further comprises a security camera for providing the APU with visual data relating to the vehicle.

In one embodiment, the system further comprises a security volume sensor for providing a security breach signal.

In one embodiment, the RF receiver and decoder is a TV receiver and decoder.

In another embodiment, the RF receiver and decoder is a radio receiver and decoder.

Preferably, all the components are implemented on the same silicon die.

Preferably, some or all of the components can operate simultaneously.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified functional block diagram of a basic system allowing reception and playback of live TV signals, constructed and operative in accordance with a preferred embodiment of the present invention.

FIG. 2 is a simplified functional block diagram of automotive entertainment system.

FIG. 3 is a simplified functional block diagram of integrated automotive entertainment and navigation system.

FIG. 4 is a simplified functional block diagram of integrated automotive entertainment, navigation and communication system.

FIG. 5 is a simplified functional block diagram of integrated automotive entertainment, navigation, communication and control center.

FIG. 6 is a simplified functional diagram of an integrated automotive entertainment, navigation, communication and control center on a chip.

### DESCRIPTION OF THE PREFERRED EMBODIMENTS

Embodiments of the present invention comprise an improved apparatus and method for audio and video processing of multiple audio and video streams. The principles and operation of an apparatus and method according to the present invention may be better understood with reference to the drawings and accompanying description.

Before explaining at least one embodiment of the invention in detail it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

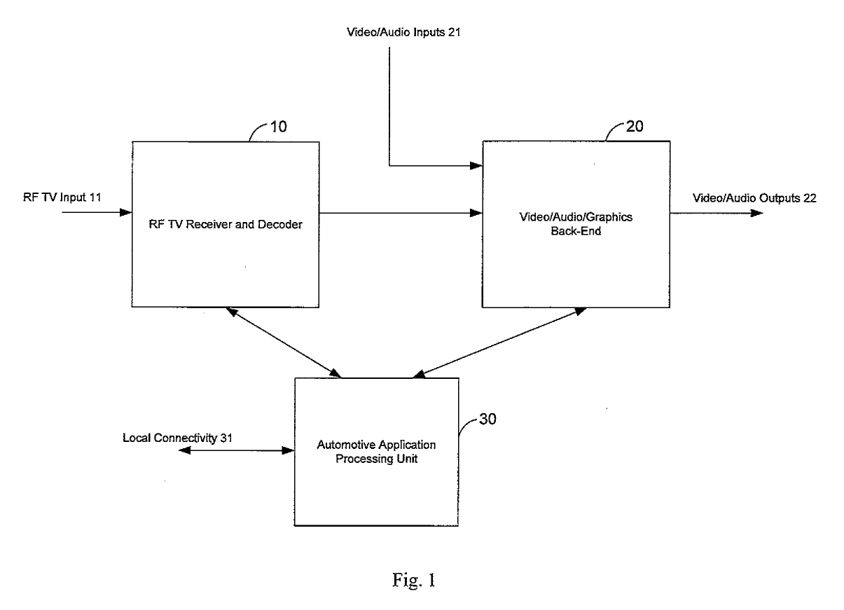

FIG. 1 is a block diagram of a simple automotive entertainment system for reception and playback of live TV signals constructed and operative according to one embodiment of the invention. By automotive it is meant to include hereinafter any mobile vehicle, on ground in air or sea. In this embodiment, the TV and radio reception and playback system comprises RF TV input bus 11, connected to a REF TV receiver and decoder unit 10. The RF TV input may be received from an antenna or from another component of the vehicle. The RF TV receiver and decoder unit 10 is also connected to the video/audio/graphics back-end unit 20. The video/audio/graphics back-end unit 20 is also connected to a video/audio input bus 21 and video/audio output bus 22. This embodiment also comprises an automotive Application Processor Unit (APU) 30 that also connects to the local connectivity bus 31. The APU 30 controls operation of the RF TV receiver and decoder unit 10 and the video/audio/graphics back-end unit 20. The APU 30 also performs various system tasks and runs a graphics user application that allows a viewer to control the TV playback, select channels etc. The local connectivity bus 31 can be used to connect to the APU a wide range of peripherals such as wireless transceivers, USB devices such as disk-on-key, hard drives, GPS receiver etc. In one of the embodiments of the invention, the RF TV receiver and decoder 10 comprises one or more TV tuners, analog to digital converters and TV demodulators, and performs reception and decoding of RF TV signals. The RF TV receiver and decoder 10 output, in the form of a digitized transport stream containing encoded TV signals, is then transferred to the video/audio/graphics back-end unit 20. In one of the embodiments of the invention, the video/audio/graphics back-end unit 20 comprises a transport demultiplexor, a video decoder, an audio decoder, a graphics engine and a display processor that renders video and graphics. The video/audio/graphics back-end unit 20 receives the digitized transport streams from the RF TV receiver and decoder 10, demultiplexes them into video and audio streams, decodes video and audio streams, generates graphics, such as user interface, renders the graphics with the video and plays back the combined layout using the video/audio outputs bus 22. In one of the embodiments of the invention, the video/audio inputs bus 21 is used to connect to local video/audio sources such as game console, media player, DVD/HD-DVD/Blu-Ray player etc. for rendering and playing digital or analog video and audio contents.

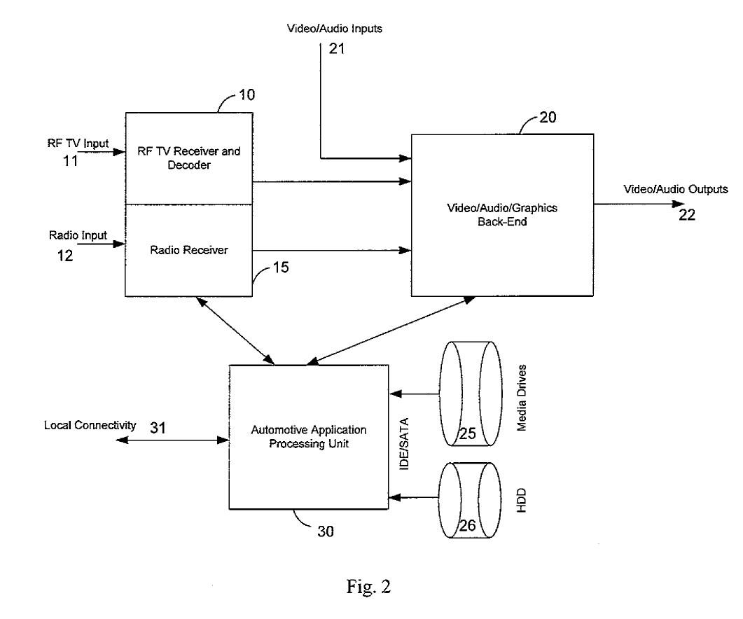

FIG. 2 is a block diagram of an automotive entertainment system according to another embodiment of the invention. In addition to the elements described in relations to FIG. 1, in this embodiment, the entertainment system also comprises radio receiver 15, RF radio input bus 12, a wide range of media drives 25 including, by the way of non-limiting examples, CD drive, DVD drive, HD-DVD drive or Blu-Ray drive, and a solid state disk, i.e. Hard Disk Drive (HDD) 26. The HDD 26 may be a hard-disk, flash disk, or any other non-volatile memory. In one of the embodiments, the radio input bus 12 is used to receive terrestrial or satellite radio signals from antennae and transfer them to the radio receiver 15. In one of the embodiments of the invention, the radio receiver 15 comprises tuner, analog to digital converter and digital demodulator and decoder of radio signal. The decoded radio signal is transferred from radio receiver 15 to the back-end 20 where it may be processed and outputted to a sound device. The processing, of back-end 20, may comprise filtering and noise reduction. In one of the embodiments of the invention, the media drives 25 and the hard disk drive 26 are connected to the APU 30 through a standard connection such as IDE or Serial ATA. In one embodiment of the invention, the CD or DVD or HD-DVD or Blu-Ray player software is executed by the APU 30. The media streams are transferred to the back-end 20 which demultiplexes them into individual video, audio and data streams, decodes the individual streams, optionally deciphers them if necessary, optionally processes them, optionally stores them on HDD 26 and plays them back.

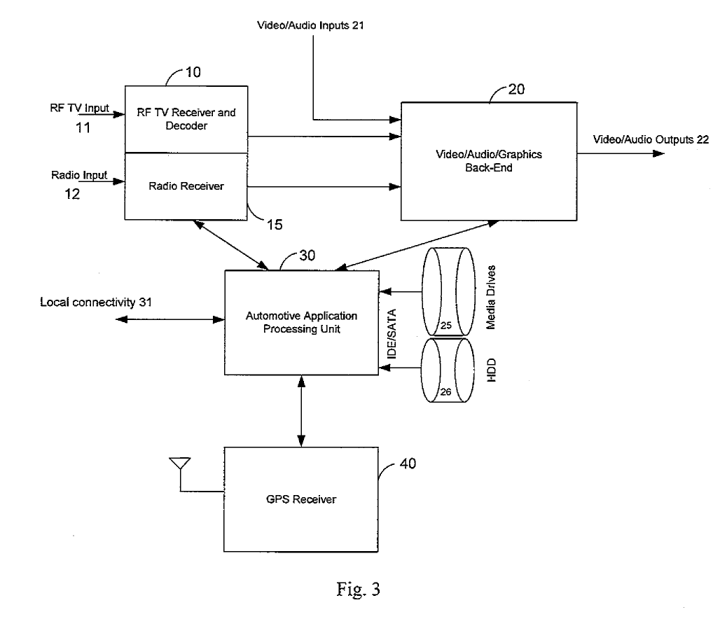

FIG. 3 is a block diagram of an automotive entertainment and navigation system according to an embodiment of the present invention. In addition to the elements described in relations to FIG. 2, the shown entertainment and navigation system also comprises a Global Positioning System (GPS) receiver 40. In an embodiment of the invention, the GPS receiver 40 is used to provide an indication of the location of the vehicle. This info is fed into the APU 30, which executes the navigation software and provides navigation information to the driver. By the way of non-limiting example, such navigation information can be transferred to the back-end 20 and played in its video form (such as an electronic map showing the position of the vehicle) or in its audio form (such as voice guidance). In one embodiment of the invention, the map database as well as the navigation software is stored on the HDD 26. In another embodiment of the invention the system may be used for storing information on the vehicle similar to the information stored in a “black box”, for later analysis. In one embodiment, the HDD 26 can be used in multiple ways. By the way of non-limiting example, it can be used to store TV and radio programs received by the TV receiver 10 and radio receiver 15 for later playback, similar to a personal video recorder, to pause live TV or radio program, also known as time-shifting, record and store various security and control information, record and store locations used in navigation, boot the APU 30, provide long-term storage for various user applications that may be executed by the APU 30 etc.

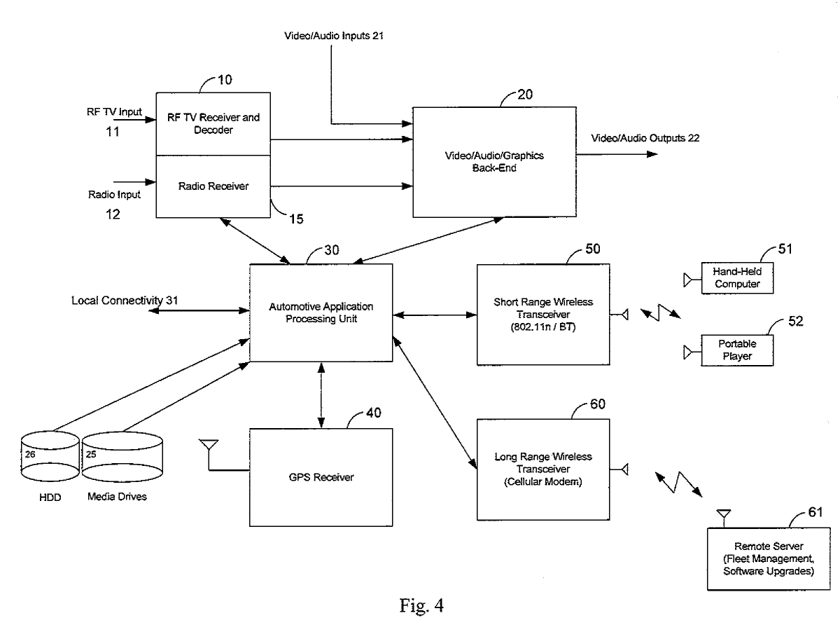

FIG. 4 is a block diagram of an automotive entertainment, navigation and communication system according to another embodiment of the invention. In addition to the elements described in relations to FIG. 3, in this embodiment the automotive entertainment, navigation and communication system also comprises a short-range wireless transceiver 50 and long-range wireless transceiver 60. The short-range wireless transceiver 50 may use any known communication protocol such as Bluetooth, 802.11n etc. The long-range wireless transceiver 60 may be a cellular modem or any other known long-range transceiver. In one embodiment of the invention, short-range wireless transceiver 50 is used to provide wireless connectivity inside the vehicle. By the way of non-limiting example, it allows passengers using portable computers 51 and portable media players 52 to access the back-end 20 to playback media stored on these portable devices. It also allows the download of media files stored on the HDD 26 or media drives 25 onto these portable devices, or vice versa. In one of the embodiments, long-range wireless transceiver 60 is used to provide broadband wireless connectivity outside the vehicle. By the way of another non-limiting example, it allows broadband internet access, information exchange with remote fleet manager server 61, used to exchange control, management and security information, upgrading the automotive software etc. By the way of another non-limiting example, it allows passengers using portable internet browsers and portable email receivers to browse the Internet and exchange emails with remote servers. In one of the embodiments, both short-range wireless transceiver 50 and long-range wireless transceiver 60 may be combined in a single wireless transceiver implementation, to save costs and improve efficiency of communication.

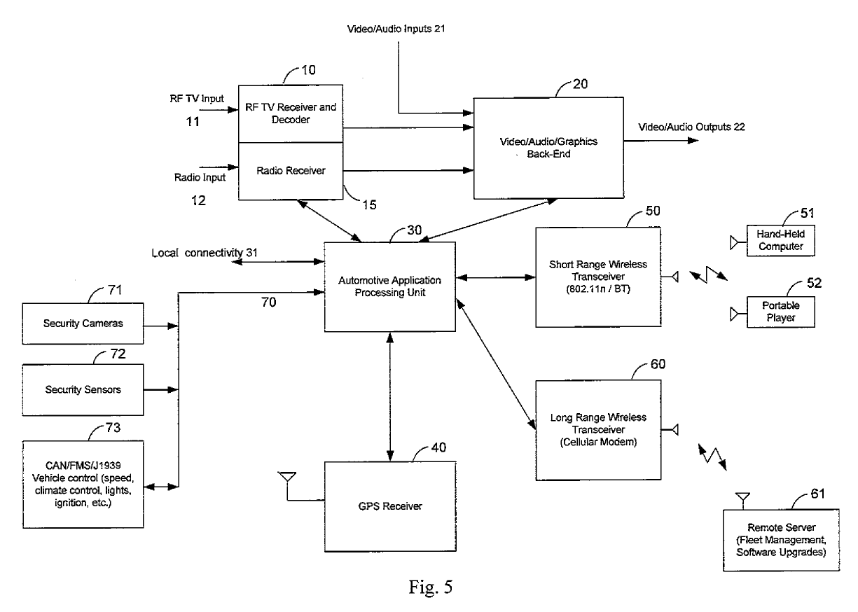

FIG. 5 is a block diagram of an automotive entertainment, navigation, communication and control system according to another embodiment of the invention. In addition to the elements described in relation to FIG. 4, the automotive entertainment, navigation, communication and control system of this embodiment also comprises security and control enhancements. In an embodiment, the security and control bus 70 connects the APU 30 to security cameras 71, security sensors 72, and a wide variety of control and security fixtures 73, including by the way of non-limiting example, a vehicle bus such as FMS or CAN-BUS, the ignition system, cruise control, external and cabin lights and climate control. Security sensors 72 may include for example, security volume sensors, or other types of security sensors for detecting a breach of security. In an embodiment of the invention, security cameras 71 comprise cameras installed within the cabin, to prevent theft or malicious tampering, as well as external cameras used to “show” the driver and the vehicle control system the exterior at various angles and directions (by the way of a non-limiting example, a rear view), or for black-box applications that could later be used to analyze accidents.

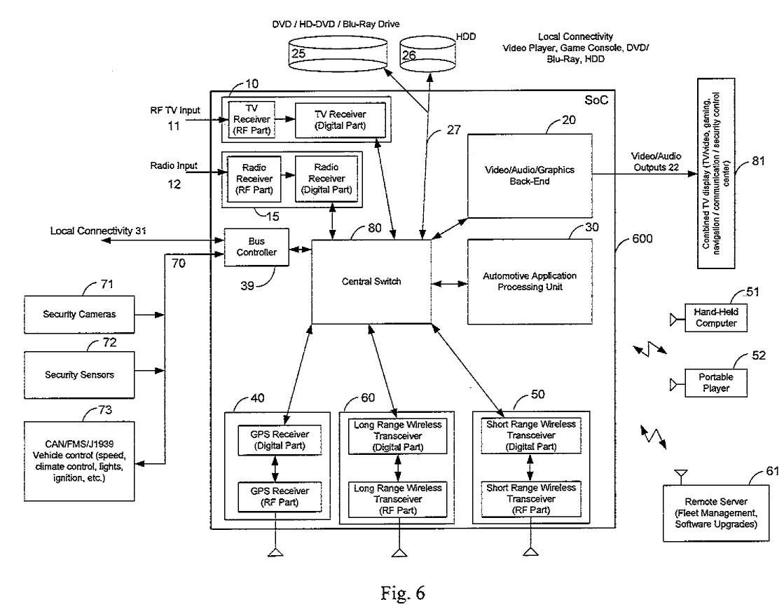

FIG. 6 is a block diagram of the automotive entertainment, navigation, communication and control system “on chip” according to an embodiment of the invention. In one embodiment of the invention, some or all functionality of the automotive entertainment, navigation, communication and control system is implemented on a single die, in a form of System on Chip (SoC) 600. The SoC 600 may comprise a central switch 80 that operates as a router, allowing various units and blocks of the SoC 600 to communicate with each other. In one embodiment, all parts of the entertainment, navigation, communication and control system can operate simultaneously and in parallel, and the APU 30 provides enough performance to implement software tasks associated with these functionalities. Some of the elements implemented on SoC 600 such as the video/audio/graphics back-end 20 perform similarly as described in relations to FIG. 5. The video/audio/graphics back-end 20 output, may be sent, on Video/Audio bus 22, to a display 81 which may be, for example, a combined TV display. GPS Receiver 40, Long Range Wireless Transceiver 60, and Short Range Wireless Transceiver 50, may be divided each into two parts analog and digital for SoC implementation constraints reasons, however, their overall essential functioning is similar to the described above in relations to FIG. 5. The same is true for TV receiver 10 and Radio Receiver 15, which may also be divided each into two parts analog and digital for SoC implementation constraints reasons with their essential functioning is similar to the described above in relations to FIG. 5. The RF TV Input 11 and Radio Input 12 are essentially as described in relations to FIG. 5. Bus controller 39 may also be implemented in SoC 600 in order to control the local connectivity bus 31, which connects to the other automotive components, and the security bus 70, which connects to the security components 71-73, described in relations to FIG. 5. Central switch 80 may also be connected to a HDD 26 or to any number of media drives 25 by bus 27. The other portable peripherals 51, 52, and server 61 may be connected and used as described in relations to FIG. 5.

In one of the embodiments of the invention, as shown in FIG. 6, the APU 30, the RF TV receiver 10, the radio receiver 15, the video/audio/graphics back-end 20, the GPS receiver 40, the short-range wireless receiver 50, the long-range wireless receiver 60, the bus controller 39, and the central switch 80 are all implemented on the same silicon (or other technology base such as SiGe) die. By a way of non-limiting example, a driver can simultaneously operate the navigation and the control systems while listening to satellite radio, while passages simultaneously view TV programs, browse Internet and exchange emails, while the vehicle control accesses a remote server for software updates and fleet management information.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Implementation of the invention involves performing or completing certain selected tasks or steps manually, automatically, or a combination thereof. Moreover, according to actual instrumentation and equipment of embodiments of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. An automotive entertainment, navigation and communication system comprising:
a. an RF receiver and decoder for receiving input signals, decoding said signals and outputting the decoded signals;
b. a back-end for processing video, audio, or graphics, of said decoded signals;
c. a GPS receiver for receiving terrestrial data;
d. an APU connected to said RF receiver, said back-end, and said GPS receiver, for processing said signals and said terrestrial data, and for controlling said RF receiver, said back-end, and said GPS receiver.

2. A system according to claim 1, further comprising a non volatile memory for storing information.

3. A system according to claim 1, further comprising a media drive for playing audio or video data.

4. A system according to claim 1, further comprising a short range wireless transceiver for communicating between the APU and portable peripherals;

5. A system according to claim 1, further comprising a long range wireless transceiver for communicating between the APU and a remote server.

6. A system according to claim 1, further comprising a security camera for providing the APU with visual data relating to the vehicle.

7. A system according to claim 1, further comprising a security volume sensor for providing a security breach signal.

8. A system according to claim 1, where the RF receiver and decoder is a TV receiver and decoder.

9. A system according to claim 1, where the RF receiver and decoder is a radio receiver and decoder.

10. A system according to claim 1 where all the components are implemented on the same silicon die.

11. A system according to claim 10 where some or all of the components can operate simultaneously.
